(19) United States
(12) Patent Application Publication
(10) Pub. No.: US 2020/0166352 A1
(43) Pub. Date: May 28, 2020

(54) APPARATUS AND METHOD FOR ESTABLISHING DUAL PATH PLAN AND DETERMINING ROAD DETERMINATION AREA FOR AUTONOMOUS DRIVING

(71) Applicant: ELECTRONICS AND TELECOMMUNICATIONS RESEARCH INSTITUTE, Daejeon (KR)

(72) Inventors: Kyoung Hwan An, Daejeon (KR); Sung Hoon Kim, Daejeon (KR); Jin Woo Kim, Daejeon (KR); Myung Wook Park, Daejeon (KR); Sang Woo Lee, Daejeon (KR); Yong Geon Choi, Daejeon (KR)

(21) Appl. No.: 16/684,867

(22) Filed: Nov. 15, 2019

(30) Foreign Application Priority Data
Nov. 27, 2018 (KR) 10-2018-0147909
Sep. 30, 2019 (KR) 10-2019-0121228

(51) Int. Cl. G01C 21/34; G05D 1/00; B60W 30/09

(52) U.S. Cl. CPC G01C 21/3415; G05D 1/0088; B60W 2550/10; G05D 2201/0213; B60W 30/09

(57) ABSTRACT

An apparatus and method for establishing a dual path plan to allow an autonomous vehicle to keep traveling without stopping even when the vehicle cannot follow a global path discovered in advance and for determining a road area for choosing an obstacle to be determined on the basis of the dual path plan. The apparatus includes an input unit configured to receive travel information of an autonomous vehicle, a memory configured to store a program for establishing a dual path plan and determining a road determination area for autonomous driving by using the travel information, and a processor configured to execute the program, wherein the processor establishes the duel path plan by setting a default path such that the autonomous vehicle keeps traveling and by setting a current global path in consideration of a global path and a current location of the autonomous vehicle.

### CROSS-REFERENCE TO RELATED APPLICATIONS

This application claims priority to and the benefit of Korean Patent Application No. 10-2018-0147909, filed on Nov. 27, 2018, and Korean Patent Application No. 10-2019-0121228, filed on Sep. 30, 2019, the disclosure of which is incorporated herein by reference in its entirety.

### BACKGROUND

### 1. Field of the Invention

The present invention relates to an apparatus and method for establishing a dual path plan to allow an autonomous vehicle to keep traveling without stopping even when the vehicle cannot follow a global path discovered in advance and for determining a road area for choosing an obstacle to be determined on the basis of the dual path plan.

### 2. Discussion of Related Art

Autonomous driving systems according to the related art have operated based on the assumption that autonomous vehicles can always follow global paths set in advance at the start of autonomous driving.

However, such global paths may not be followed in a real road situation. In this case, vehicles should stop to rediscover new global paths and thus may obstruct nearby traffic flow.

### SUMMARY OF THE INVENTION

The present invention is directed to providing an apparatus and method for establishing a dual path plan and determining a road determination area for autonomous driving, the apparatus and method being capable of maintaining the dual path plan including a default path and a current global path in addition to a global path planned before autonomous driving is started, finding a travelable path, and determining a road area where an obstacle of interest may be present.

According to an aspect of the present invention, there is provided an apparatus for establishing a dual path plan and determining a road determination area for autonomous driving, the apparatus including an input unit configured to receive travel information of an autonomous vehicle, a memory configured to store a program for establishing a dual path plan and determining a road determination area for autonomous driving by using the travel information, and a processor configured to execute the program, wherein the processor establishes the duel path plan by setting a default path such that the autonomous vehicle keeps traveling and by setting a current global path in consideration of a global path and a current location of the autonomous vehicle.

According to another aspect of the present invention, there is provided a method of establishing a dual path plan and determining a road determination area for autonomous driving, the method including setting a default path using road information and a location of an autonomous vehicle when the autonomous vehicle is not present on a global path; setting a current global path and establishing a dual path plan in consideration of the global path and the location of the autonomous vehicle; and setting an obstacle determination area on the basis of the default path and the current global path, evaluating stability related to collision with an obstacle, and determining a travel action.

### BRIEF DESCRIPTION OF THE DRAWINGS

FIG. 1 shows a case where an autonomous vehicle cannot follow a global path according to the related art.

FIG. 2 is a block diagram showing an apparatus for establishing a dual path plan and determining a road determination area for autonomous driving according to an embodiment of the present invention.

FIG. 3 shows a default path according to an embodiment of the present invention.

FIG. 4 shows a default path generation scheme according to an embodiment of the present invention.

FIG. 5 shows a default path generation process according to an embodiment of the present invention.

FIG. 6 shows a process of setting an obstacle determination area on the basis of a default path according to an embodiment of the present invention.

FIG. 7 shows an example of setting an obstacle determination area on the basis of a default path according to an embodiment of the present invention.

FIG. 8 shows a process of setting an obstacle determination area on the basis of a current global path according to an embodiment of the present invention.

FIG. 9 shows an example of setting an obstacle determination area on the basis of a current global path according to an embodiment of the present invention.

FIG. 10A and FIG. 10B show flowcharts for autonomous driving according to an embodiment of the present invention.

FIG. 11 shows a system for establishing a dual path plan and determining a road determination area for autonomous driving according to an embodiment of the present invention.

### DETAILED DESCRIPTION OF EXEMPLARY EMBODIMENTS

These and other objects, advantages and features of the present invention, and implementation methods thereof will be clarified through following embodiments described with reference to the accompanying drawings.

The present invention may, however, be embodied in different forms and should not be construed as limited to the embodiments set forth herein. Rather, these embodiments are provided so that this disclosure will fully convey the objects, configurations, and effects of the present invention to those skilled in the art. The scope of the present invention is defined solely by the appended claims.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. The terms “comprises” and/or “comprising,” when used in this specification, specify the presence of stated elements, steps, operations, and/or components, but do not preclude the presence or addition of one or more other elements, steps, operations, and/or components.

Hereinafter, in order to help those skilled in the art to understand the present invention, the background of the present invention will be described first, and then the embodiments of the present invention will be described.

A conventional autonomous driving system has operated on the basis of the assumption that an autonomous vehicle can always follow a global path set in advance at the start of autonomous driving.

However, such a global path may not be followed in a real road situation because of a lane change prohibition situation caused by traffic congestion, a construction situation, an accident situation, or the like.

According to the related art, when it is not possible for a vehicle to follow a global path, the vehicle may stop and rediscover a new global path and then travel along the new path. However, the global path re-discovering process may hinder nearby traffic flow.

The autonomous vehicle should establish a path plan from an origin to a destination using a lane-level high-definition map and maintain the result (a set of links of a road network) in order to travel to the destination. This path is referred to as a global path.

However, as described above, autonomous vehicles determine an action to always follow global paths, but it may not be possible to follow the global paths depending on the road situation.

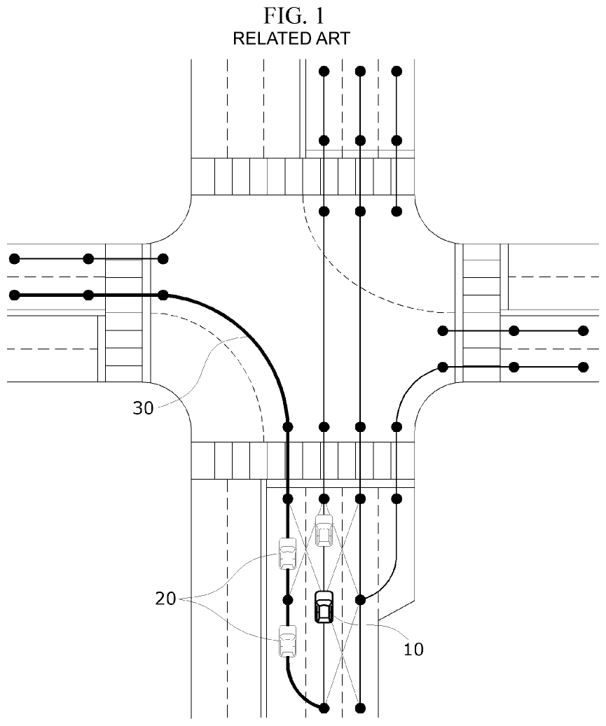

Referring to FIG. 1, in order to follow a global path 30 marked in green, an autonomous vehicle 10 should change lanes to the first lane and turn left at an intersection. However, it is not possible to change lanes due to obstacle vehicles 20 located on the first lane.

Accordingly, when the autonomous vehicle 10 reaches the intersection, the autonomous vehicle 10 may no longer follow the global path because it cannot turn left.

According to the related art, when an autonomous vehicle cannot follow a global path, the autonomous vehicle stops and rediscovers a new global path and then travels along the new global path.

However, since a lane-level high-definition map is utilized for autonomous driving unlike vehicle navigation, it takes more time to rediscover a path and thus nearby vehicle flow is obstructed while a new global path is being rediscovered.

Also, according to the related art, an action is determined after a travel situation is determined for all recognized vehicles or after a travel situation is determined for the current travel lane and the left and right lanes with respect to a current location of a vehicle. In this case, the determination requires a lot of time, and thus when a vehicle is not currently present on a global path, an obstacle necessary to be determined may be missed.

The present invention is proposed to solve the above problems and provides an apparatus and method for always finding a path along which an autonomous vehicle can travel in an urban environment and determining a road area where an obstacle of interest may be present.

According to the present invention, by continuously maintaining a dual path plan, including a default path and a current global path (i.e., a global path from a link where an autonomous vehicle is currently located to a link separated by a distance smaller than D_{global_path} among all global paths) in addition to a global path planed before autonomous driving is started, it is possible to always find a path along which an autonomous vehicle can travel in an urban environment and determine a road area where an obstacle of interest may be present.

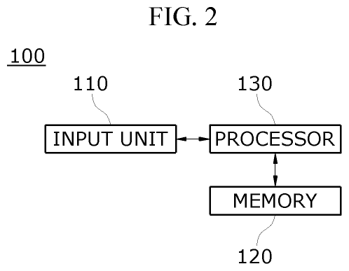

FIG. 2 is a block diagram showing an apparatus 100 for establishing a dual path plan and determining a road determination area for autonomous driving according to an embodiment of the present invention.

The apparatus 100 for establishing a dual path plan and determining a road determination area for autonomous driving according to the present invention may include an input unit 110 configured to receive travel information of an autonomous vehicle, a memory 120 configured to store a program for establishing a dual path plan and determining a road determination area for autonomous driving by using the travel information, and a processor 130 configured to execute the program. The processor 130 establishes the dual path plan by setting a default path such that the autonomous vehicle keeps traveling and by setting a current global path in consideration of a global path and a current location of the autonomous vehicle.

The processor 130 according to an embodiment of the present invention generates the default path in consideration of the connection angle of the next link connected to the current link on a road network where the autonomous vehicle is present.

The processor 130 according to an embodiment of the present invention performs link addition in consideration of the connection angle until the length of the default path to which the current link and the next link are connected reaches a predetermined length.

The processor 130 according to an embodiment of the present invention sets an obstacle determination area on the basis of the default path.

The processor 130 according to an embodiment of the present invention evaluates stability related to an obstacle in the obstacle determination area set on the basis of the default path, checks whether a lane change to follow the global path is possible, and determines a travel action.

The processor 130 according to an embodiment of the present invention sets the current global path on the basis of a point that is most adjacent to the current location of the autonomous vehicle on the global path and sets the obstacle determination area on the basis of the current global path.

The processor 130 according to an embodiment of the present invention evaluates stability related to an obstacle in the obstacle determination area, plans a local path such that there is no collision with an obstacle, and then determines a travel action.

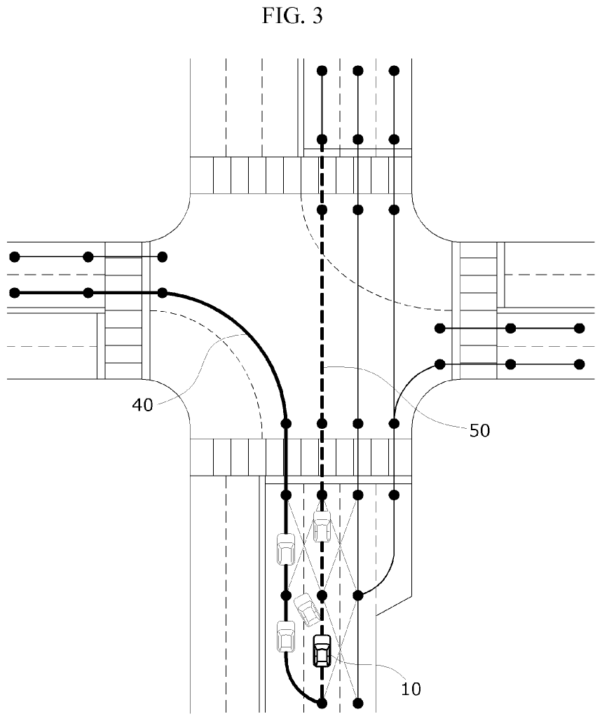

FIG. 3 shows a default path according to an embodiment of the present invention.

The processor 130 according to an embodiment of the present invention periodically sets default paths so that the default paths are always present on the basis of the current location of the autonomous vehicle.

Depending on a road traffic situation, the autonomous vehicle 10 may not follow a global path 40, but a default path 50 is continuously generated on the basis of the current location of the autonomous vehicle 10. Thus, the autonomous vehicle 10 is always present on the default path 50.

Referring to FIG. 3, the current global path 40 and the default path 50 are maintained in a dual manner, and the autonomous vehicle 10 is present on one of the two paths.

Referring to FIG. 3, the autonomous vehicle 10 should change lanes to the first lane in order to turn left at the intersection to follow the current global path 40.

However, when the lane change is not possible to due to nearby vehicles, the autonomous vehicle 10 keeps traveling autonomously using the default path 50 before a new global path is rediscovered, and thus does not obstruct nearby traffic flow. When a new global path is rediscovered, the autonomous vehicle 10 follows the rediscovered global path.

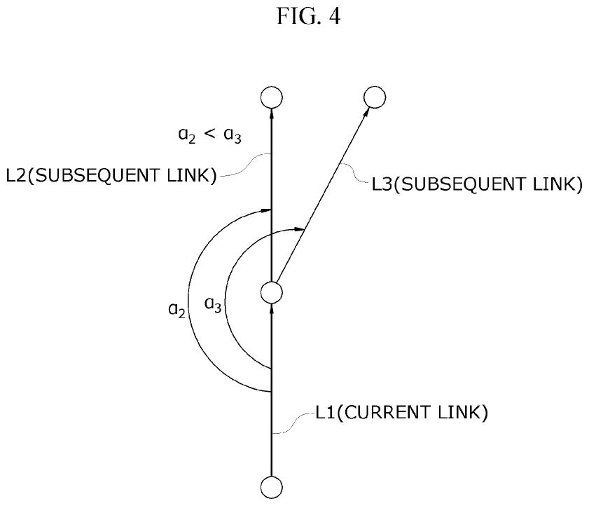

FIG. 4 shows a default path generation scheme according to an embodiment of the present invention.

The processor 130 according to an embodiment of the present invention sets a link on a road network where the autonomous vehicle is currently present as a first link L1, extends the first link L1 to a link having a minimum connection angle, which is one of subsequent links L2 and L3 connected to the first link L1, and generates a default path up to a predetermined range of distance.

Referring to FIG. 4, in the case of the current link L1, L2 and L3 are provided as the subsequent links. The default path is obtained by extending the current link L1 to L2, which has a smaller connection angle than L3.

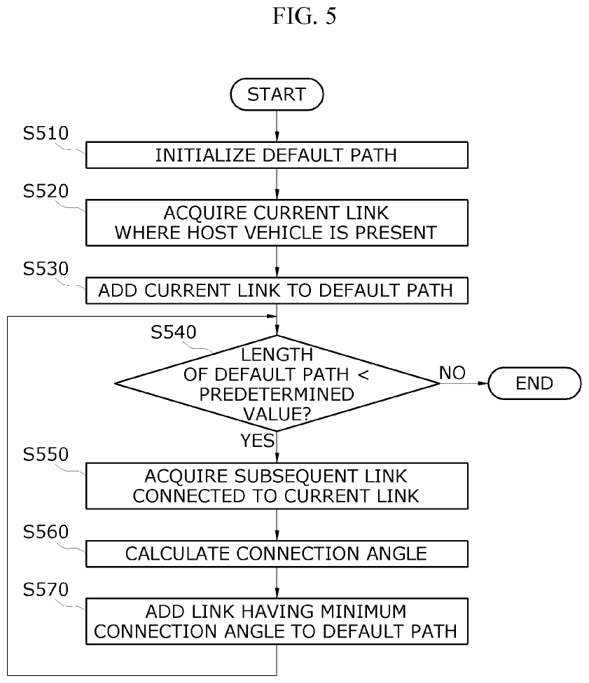

FIG. 5 shows a default path generation process according to an embodiment of the present invention.

First, a processor according to an embodiment of the present invention initializes a default path (S510).

Subsequently, as described above with reference to FIG. 4, the processor acquires a link where an autonomous vehicle is currently present (S520) and adds the link to the default path (S530).

Subsequently, the processor compares the length of the default path to which the current link is added to a predetermined length D_{default_path} of the default path (S540).

When the comparison result of S540 indicates that the length of the default path to which the current link is added is greater than or equal to the predetermined length of the default path, the processor terminates the generation of the default path.

When the comparison result of S540 indicates that the length of the default path to which the current link is added is smaller than the predetermined length of the default path, the processor acquires information regarding subsequent links connected to the current link (S550), calculates connection angles between the current link and the subsequent links (S560), and adds a subsequent link having the minimum connection angle to the default path (S570).

Operations S550 to S570 are repeated until the comparison result of S540 indicates that the length of the default path reaches the predetermined value.

In order to determine a travel action in an autonomous driving system, danger evaluation for obstacles is necessary. To this end, it is important to choose obstacles of interest.

The processor 130 according to an embodiment of the present invention sets an obstacle determination area on the basis of the above-described dual path plan.

In order to keep the current travel lane or change lanes to the left or right, the autonomous vehicle should distinguish vehicles traveling on the current travel lane from vehicles traveling on the left or right lane.

In the case of an express way, a road network has a simple structure, and thus it is possible to apparently distinguish the current travel lane from a left or right lane travel region. However, in the case of a general road, each link is connected to several other links, and thus the definition of left and right lanes may be ambiguous.

Therefore, according to an embodiment of the present invention, by defining front and rear areas and left and right areas on the basis of the default path and the current global path and setting an area for determining an obstacle on the lanes in order to define the current travel lane and the left and right lane areas, it is possible to easily find a target obstacle to be considered when an action is determined.

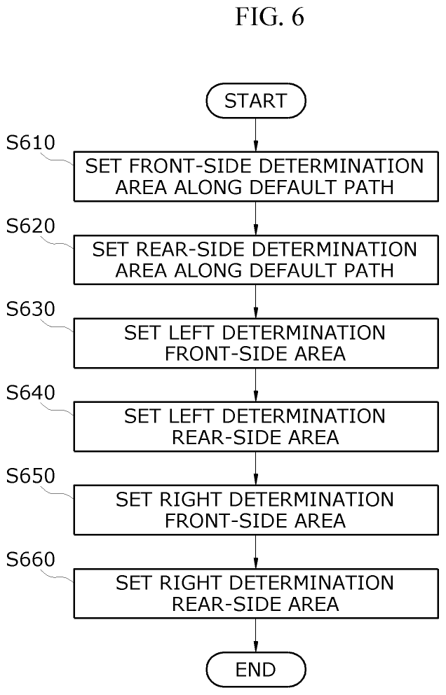

FIG. 6 shows a process of setting an obstacle determination area on the basis of a default path according to an embodiment of the present invention.

First, the processor 130 according to an embodiment of the present invention sets a travel lane front-side determination area EF to D_{decision_front} using a default path (S610).

Subsequently, the processor 130 sets a travel lane rear-side determination area ER to D_{decision_rear} (S620).

A left determination front-side area LF and a left determination rear-side area LR are set using a link present to the left of a link to which the travel lane front-side determination area EF and the travel lane rear-side determination area ER belong in a road network (S630 and S640), and a right determination front-side area RF and a right determination rear-side area RR are set using a link present to the right of the link to which the travel lane front-side determination area EF and the travel lane rear-side determination area ER belong in the road network (S650 and S660).

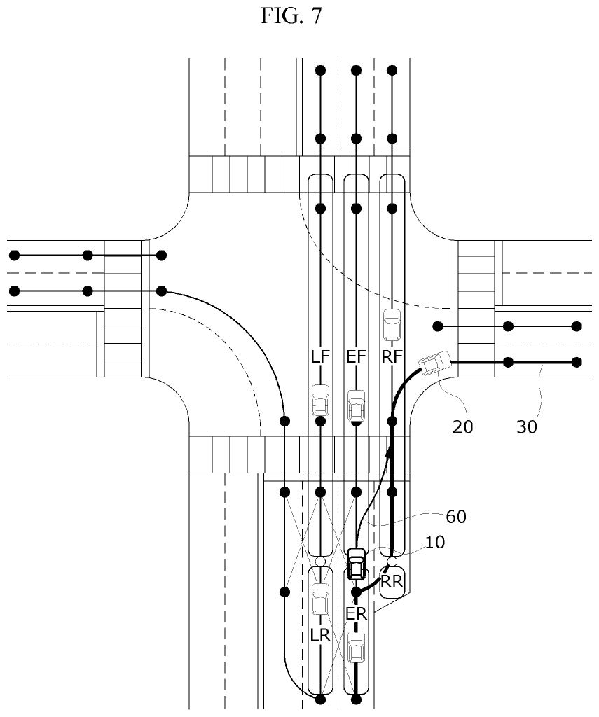

FIG. 7 shows an example of setting an obstacle determination area on the basis of a default path according to an embodiment of the present invention.

The processor 130 according to an embodiment of the present invention sets an obstacle determination area in preparation for when the autonomous vehicle 10 cannot follow a global path as shown in FIG. 7.

A local path 60 is a path along which the autonomous vehicle 10 may actually move, and the autonomous vehicle 10 actually follows the local path 60.

Depending on the structure of the road network, the current global path and the default path may be the same as each other and may also have the same determination area.

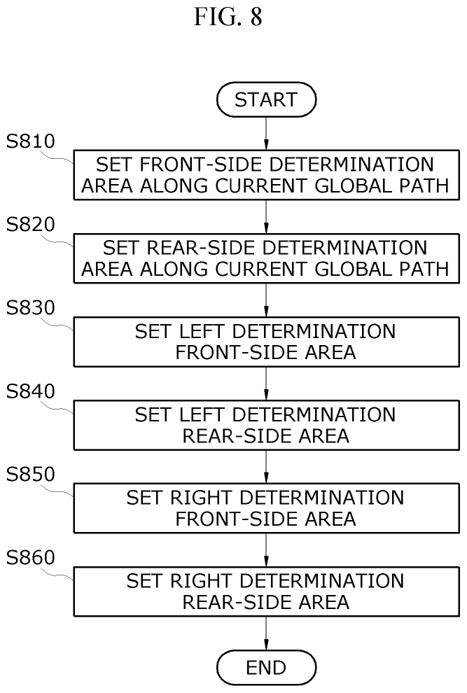

FIG. 8 shows a process of setting an obstacle determination area on the basis of a current global path according to an embodiment of the present invention.

Since the autonomous vehicle may not follow the global path, the processor 130 according to an embodiment of the present invention uses the current global path on the basis of a point closest to the current location of the autonomous vehicle to set the travel lane front-side determination area to D_{decision_front} (S810) and set the travel lane rear-side determination area to D_{decision_rear} (S820).

Subsequently, the left determination front-side area LF and the left determination rear-side area LR are set using a link that is left with respect to the travel lane front-side determination area EF (S830 and S840), and the right determination front-side area RF and the right determination rear-side area RR are set using a link that is right with respect to the travel lane front-side determination area EF (S850 and S860).

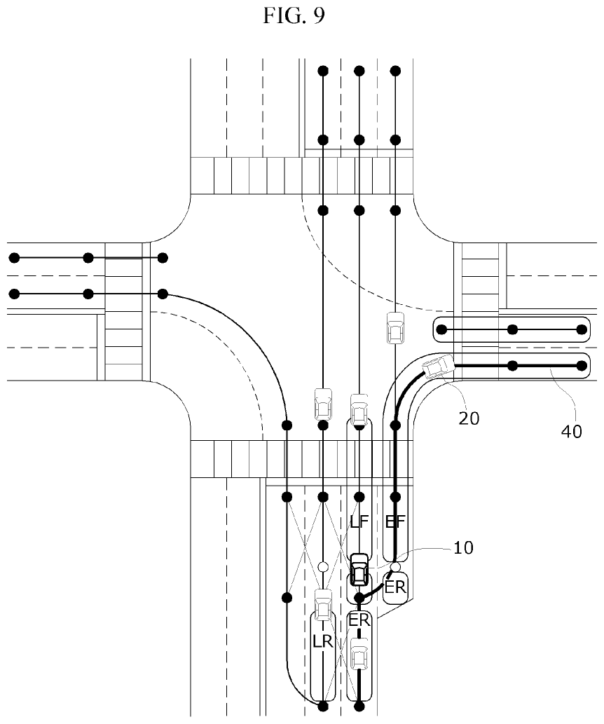

FIG. 9 shows an example of setting an obstacle determination area on the basis of a current global path according to an embodiment of the present invention.

The processor 130 of the autonomous vehicle 10 may set the obstacle determination areas EF, ER, LR, and LF on the basis of the current global path 40. As shown in FIG. 9, when no left link is temporarily present among the links of the current global path 40, the obstacle determination area may not be continuous.

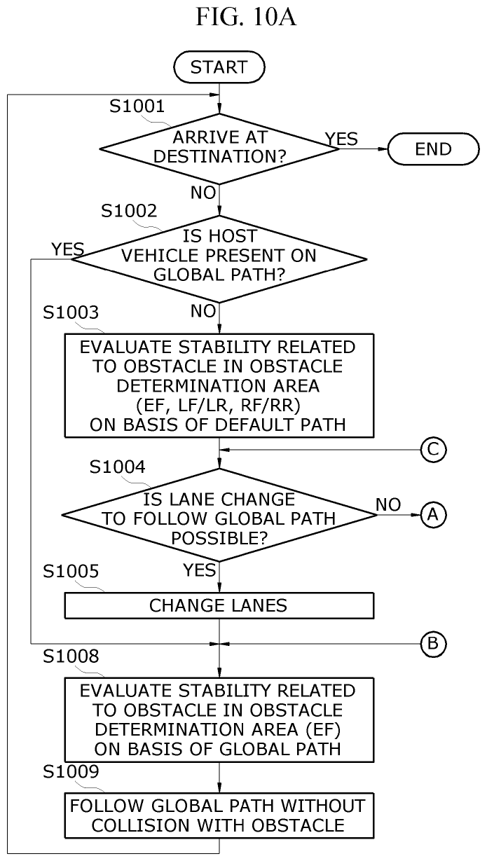

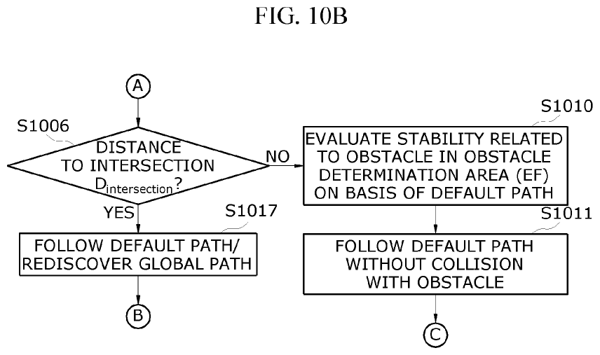

FIG. 10A and FIG. 10B show flowcharts for autonomous driving according to an embodiment of the present invention.

As shown in FIG. 10A and FIG. 10B, the processor 130 according to an embodiment of the present invention may allow autonomous driving to be stably and continuously performed by using a current global path, default path, and determination area even when the autonomous vehicle cannot follow a global path.

It is assumed that a global path from an origin to a destination has been already planned before the sequence shown in FIG. 10A and FIG. 10B.

First, the processor 130 checks whether the autonomous vehicle has arrived at the destination (S1001).

In S1001, the processor 130 terminates autonomous driving when the autonomous vehicle has arrived at the destination. When it is determined in S1001 that the autonomous vehicle has not arrived at the destination yet, the processor 130 checks whether the autonomous vehicle is currently present on the global path (S1002).

When it is determined in S1002 that the autonomous vehicle is present on the global path, the processor 130 evaluates stability related to collisions with obstacles in the obstacle determination area on the basis of the current global path (S1008). Then, the processor 130 plans a local path on the basis of the global path such that there are no collisions with the obstacles and controls the vehicle to travel autonomously (S1009).

When it is determined in S1002 that the autonomous vehicle is not present on the global path, the processor 130 evaluates stability related to obstacles in the obstacle determination area on the basis of the default path (S1003) and checks whether a lane change to follow the global path is possible (S1004).

When it is determined in S1004 that the lane change is possible, the processor 130 changes lanes to follow the global path (S1005), evaluates stability related to collisions with obstacles in the obstacle determination area on the basis of the global path (S1008), and plans a local path on the basis of the global path such that there are no collisions with the obstacles and controls the vehicle to travel autonomously (S1009).

When it is determined in S1004 that the lane change to follow the global path is not possible according to a traffic situation, the processor 130 compares a distance to the intersection to a lane changeable distance D_{intersection} (S1006).

When the comparison result of S1006 indicates that the distance to the intersection is smaller than the lane changeable distance, the processor 130 follows the default path and rediscovers a new global path (S1007).

Subsequently, when the rediscovery of the global path is complete, the processor 130 follows the global path through safety evaluation (S1008 and S1009).

When the comparison result of S1006 indicates that the distance to the intersection is larger than the lane changeable distance, that is, when it is determined that the lane changeable distance still remains, the processor evaluates stability related to the obstacles in the obstacle determination area on the basis of the default path (S1010) and checks whether a lane change is possible again while following the default path such that there are no collisions (S1004).

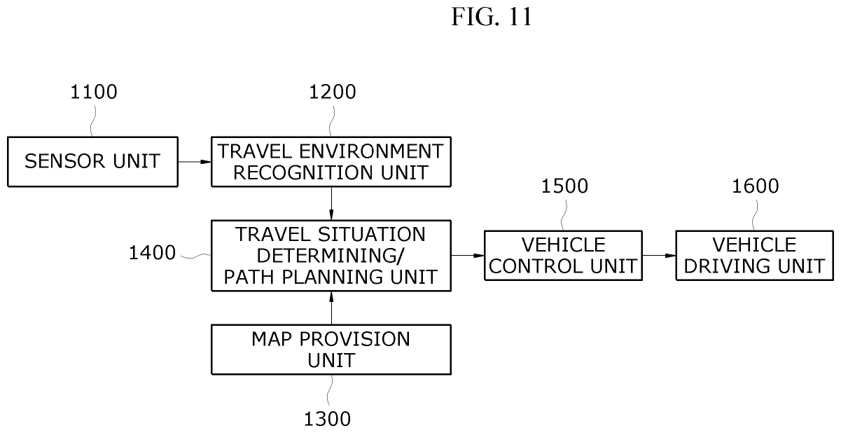

FIG. 11 shows a system for establishing a dual path plan and determining a road determination area for autonomous driving according to an embodiment of the present invention.

The system for establishing a dual path plan and determining a road determination area for autonomous driving according to an embodiment of the present invention includes a travel situation determining/path planning unit 1400 configured to receive map information from a map provision unit 1300, plan a global path, establish a dual path plan for a default path and a current global path in addition to the global path, and set an obstacle determination area and a vehicle control unit 1500 configured to control a vehicle driving unit 1600 according to command information received from the travel situation determining/path planning unit 1400.

The travel situation determining/path planning unit 1400 generates a default path in consideration of a connection state between a link where an autonomous vehicle is present and a subsequent link connected to the link.

The travel situation determining/path planning unit 1400 sets a current global path in consideration of the relationship between the global path and the current location of the autonomous vehicle.

The travel situation determining/path planning unit 1400 sets an obstacle determination area on the basis of the default path and the current global path, determines a travel action on the basis of the possibility of collision with an obstacle in the obstacle determination area, and generates a local path.

A sensor unit 1100 includes hardware devices such as a global positioning satellite (GPS) device, a radar device, a LiDAR device, a camera, an odometry device, and a vehicle-to-everything (V2X) modem in order to locate a vehicle and an obstacle.

By using data acquired from the sensor unit 1100, a travel environment recognition unit 1200 recognizes an obstacle, a road infrastructure, a traffic light, and a nearby vehicle lamp.

The travel situation determining/path planning unit 1400 plans a global path from an origin to a destination by using a detailed high-definition map received from the map provision unit 1300.

The travel situation determining/path planning unit 1400 continuously generates a default path, sets an obstacle determination area using the generated default path, determines a travel situation, and determines a travel action about whether to follow the global path, follow the default path, and change lanes.

The travel situation determining/path planning unit 1400 generates a local path along which the vehicle can travel according to the finally determined travel action.

The vehicle control unit 1500 receives the local path and the vehicle command and actually controls an actuator (a steering wheel, an engine, a brake pedal, and a gear) of the vehicle driving unit 1600.

Meanwhile, the method of establishing a dual path plan and determining a road determination area for autonomous driving according to an embodiment of the present invention may be implemented by a computer system or may be recorded in a recording medium. A computer system may include at least one processor, memory, user input device, data communication bus, user output device, and storage. The above-described elements perform data communication through the data communication bus.

The computer system may further include a network interface coupled to a network. The processor may be a central processing unit (CPU) or a semiconductor device for processing instructions stored in a memory and/or a storage.

The memory and storage may include various types of volatile or non-volatile storage media. For example, the memory may include a read-only memory (ROM) and a random access memory (RAM).

Accordingly, the method of establishing a dual path plan and determining a road determination area for autonomous driving according to an embodiment of the present invention may be implemented as a computer-executable method. When the method of establishing a dual path plan and determining a road determination area for autonomous driving according to an embodiment of the present invention is performed by a compute device, computer-readable instructions may implement the plan and determination method according to the present invention.

Meanwhile, the method of establishing a dual path plan and determining a road determination area for autonomous driving according to an embodiment of the present invention may be embodied as computer-readable codes on a computer-readable recording medium. The computer-readable recording medium includes all types of recording media where data that can be decrypted by a computer system is stored. For example, the computer-readable recording medium may include a ROM, a RAM, a magnetic tape, a magnetic disk, a flash memory, an optical data storage device, and the like. Further, the computer-readable recording media can be stored and carried out as codes that are distributed in a computer system connected to a computer network and are readable in a distributed manner.

According to an embodiment of the present invention, by always determining a travel path using a planned dual path even when an autonomous vehicle cannot follow a global path discovered in advance, it is possible to solve a problem in which an autonomous driving system according to the related art obstructs traffic flow when the system cannot follow the global path and to easily set an obstacle determination area.

According to the present invention, it is possible for a system such as Adaptive Cruise Control (ACC) and Lane Keeping Support (LKS), each of which is a kind of advanced driver-assistance system (ADAS) other than an autonomous driving system, to operate on normal roads other than express ways by using the default path.

The effects of the present invention are not limited to the aforementioned effects, and other effects not described herein will be clearly understood by those skilled in the art from the above description.

The present invention has been described above with respect to embodiments thereof. Those skilled in the art should understand that various changes in form and details may be made therein without departing from the essential characteristics of the present invention. Therefore, the embodiments described herein should be considered from an illustrative aspect rather than from a restrictive aspect. The scope of the present invention should be defined not by the detailed description but by the appended claims, and all differences falling within a scope equivalent to the claims should be construed as being encompassed by the present invention.

The method according to an embodiment of the present invention may be implemented in a computer system or may be recorded in a recording medium. A computer system may include one or more processors, a memory, a user input device, a data communication bus, a user output device, a storage, and the like. These components perform data communication through the data communication bus.

Also, the computer system may further include a network interface coupled to a network. The processor may be a central processing unit (CPU) or a semiconductor device that processes a command stored in the memory and/or the storage.

The memory and the storage may include various types of volatile or non-volatile storage mediums. For example, the memory may include a ROM and a RAM.

Thus, the method according to an embodiment of the present invention may be implemented as a method that can be executable in the computer system.

When the method according to an embodiment of the present invention is performed in the computer system, computer-readable commands may perform the producing method according to the present invention.

What is claimed is:

1. An apparatus for establishing a dual path plan and determining a road determination area for autonomous driving, the apparatus comprising:
an input unit configured to receive travel information of an autonomous vehicle;
a memory configured to store a program for establishing a dual path plan and determining a road determination area for autonomous driving by using the travel information; and
a processor configured to execute the program,
wherein the processor establishes the duel path plan by setting a default path such that the autonomous vehicle keeps traveling and by setting a current global path in consideration of a global path and a current location of the autonomous vehicle.

2. The apparatus of claim 1, wherein the processor generates the default path in consideration of connection angles of subsequent links connected to a current link on a road network where the autonomous vehicle is present.

3. The apparatus of claim 2, wherein the processor performs link addition considering the connection angles until the length of the default path obtained by connecting the current link to the subsequent link reaches a predetermined length.

4. The apparatus of claim 1, wherein the processor sets an obstacle determination area on the basis of the default path.

5. The apparatus of claim 4, wherein the processor evaluates stability related to an obstacle in the obstacle determination area that is set on the basis of the default path, checks whether a lane change to follow the global path is possible, and determines a travel action.

6. The apparatus of claim 1, wherein the processor sets the current global path on the basis of a point that is most adjacent to the current location of the autonomous vehicle on the global path and sets an obstacle determination area on the basis of the current global path.

7. The apparatus of claim 6, wherein the processor evaluates stability related to an obstacle in the obstacle determination area, plans a local path such that there is no collision with the obstacle, and controls a travel action.

8. A method of establishing a dual path plan and determining a road determination area for autonomous driving, the method comprising operations of:
(a) setting a default path using road information and a location of an autonomous vehicle when the autonomous vehicle is not present on a global path;
(b) setting a current global path and establishing a dual path plan in consideration of the global path and the location of the autonomous vehicle; and
(c) setting an obstacle determination area on the basis of the default path and the current global path, evaluating stability related to collision with an obstacle, and determining a travel action.

9. The method of claim 8, wherein the operation (a) comprises generating the default path by adding a subsequent link having a minimum connection angle among subsequent links connected to a current link on a road network where the autonomous vehicle is present.

10. The method of claim 9, wherein the operation (a) comprises repeating the link addition considering the connection angles until the length of the default path obtained by adding the current link and the subsequent link reaches a predetermined length.

11. The method of claim 8, wherein the operation (b) comprises setting the current global path on the basis of a point that is most adjacent to a current location of the autonomous vehicle on the global path.

12. The method of claim 8, wherein the operation (c) comprises evaluating stability related to an obstacle in the obstacle determination area that is set on the basis of the default path, checking whether a lane change to follow the global path is possible, and determining a travel action using information regarding a remaining distance to an intersection.

13. A system for establishing a dual path plan and determining a road determination area for autonomous driving, the system comprising:
a travel situation determining/path planning unit configured to receive map information from a map provision unit, plan a global path, establish a dual path plan for a default path and a current global path in addition to the global path, and set an obstacle determination area; and
a vehicle control unit configured to control a vehicle driving unit according to command information received from the travel situation determining/path planning unit.

14. The system of claim 13, wherein the travel situation determining/path planning unit generates the default path in consideration of connection states of a link where an autonomous vehicle is present and subsequent links connected to the link.

15. The system of claim 13, wherein the travel situation determining/path planning unit sets the current global path in consideration of a relationship between the global path and a current location of the autonomous vehicle.

16. The system of claim 13, wherein the travel situation determining/path planning unit sets an obstacle determination area on the basis of the default path and the current global path, determines a travel action according to the possibility of collision with an obstacle in the obstacle determination area, and generates a local path.
